(19) United States
(12) Patent Application Publication
(10) Pub. No.: US 2016/0183117 A1
(43) Pub. Date: Jun. 23, 2016

(54) METHOD AND APPARATUS FOR THROTTLING UPLINK DATA BASED ON TEMPERATURE STATE

(71) Applicant: MediaTek Inc., Hsin-Chu (TW)

(72) Inventors: Fu-Chieh HSU, Taipei City (TW); Pi-Yuan CHENG, Kaohsiung City (TW); Tsao-Jiang CHANG, Taipei City (TW)

(21) Appl. No.: 14/812,272

(22) Filed: Jul. 29, 2015

Related U.S. Application Data
(60) Provisional application No. 62/092,913, filed on Dec. 17, 2014.

(51) Int. Cl. H04W 28/02; H04W 72/04; H04W 52/02

(52) U.S. Cl. CPC H04W 28/0221; H04W 52/0206; H04W 72/048

(57) ABSTRACT

An apparatus for throttling uplink data based on a temperature state is provided. The apparatus includes a temperature sensor, a processor and a memory. The temperature sensor senses an internal temperature of the apparatus. The memory is operatively coupled to the processor. The processor is configured to execute a program code stored in the memory to: compare the internal temperature to a corresponding temperature range according to a predetermined table of temperature ranges; and control a packet buffer to adjust a current data rate to a corresponding target data rate according to the comparison result.

### CROSS REFERENCE TO RELATED APPLICATIONS

The present application is based on and claims the benefit of U.S. Provisional Application No. 62/092,913 filed on Dec. 17, 2014, the entirety of which is incorporated by reference herein.

### BACKGROUND

1. Field of the Invention

Aspects of the present disclosure relate generally to wireless communications network technologies, and more particularly, throttling uplink data based on a temperature state in wireless communications system.

2. Description of the Related Art

Electronic devices often contain wireless communications capabilities. For example, portable electronic devices are often provided with wireless local area network (WLAN) communications circuitry, cellular telephone communications circuitry, and satellite navigation system receiver circuitry such as Global Positioning System (GPS) receiver circuitry. Using wireless communications circuits such as these, a user may communicate with local and remote wireless networks and may receive signals from GPS satellites.

As an example, a cellular telephone may include cellular telephone transceiver circuitry that is used to make telephone calls. The cellular telephone transceiver circuitry includes power amplifier (PA) circuitry that is used to amplify radio-frequency (RF) signals so that the RF signals can be transmitted to a nearby base station.

However, a high uplink data rate may cause greater power consumption, and further leads to extreme heat issues, because the operating temperature of the cellular telephone may be influenced by the operation of the power amplifier circuitry.

Therefore, it would be desirable to be able to provide an apparatus and a method for throttling uplink data based on a temperature state.

### SUMMARY

A detailed description is given in the following implementations with reference to the accompanying drawings.

An apparatus and a method for throttling uplink data based on a temperature state are provided.

The disclosure is directed to an apparatus for throttling uplink data based on a temperature state. The apparatus comprises a temperature sensor, a processor and a memory. The temperature sensor senses an internal temperature of the apparatus. The memory is operatively coupled to the processor. The processor is configured to execute a program code stored in the memory to: compare the internal temperature to a corresponding temperature range according to a predetermined table of temperature ranges; and control a packet buffer to adjust a current data rate to a corresponding target data rate according to the comparison result.

In some implementations of the apparatus, before the comparing step, the processor further executes the program code to: calculate target data rates for each temperature range based on a temperature state; and record the target data rates for each temperature range in the predetermined table of temperature ranges. In some implementations of the apparatus, before the comparing step, the processor further executes the program code to: use a lookup table (LUT) as the predetermined table of temperature ranges; and find target data rates for each temperature range based on a temperature state from the LUT. In some implementations of the apparatus, the processor includes a timer and is configured to execute the program code stored in the memory to: start the timer to switch the packet buffer between a first operating mode and a second operating mode, wherein when the packet buffer is in the first operating mode, the packet buffer resumes transmitting data packets; and when the packet buffer is in the second operating mode, the packet buffer stops transmitting the data packets. In some implementations of the apparatus, when there are at least two packet buffers, the processor is configured to execute the program code stored in the memory to: classify data packets into at least one data flow classification according to a service type of each packet buffer; and transmit the data packets to the packet buffers according to the data flow classification for each data packet. In some implementations of the apparatus, the processor is configured to execute the program code stored in the memory to: assign a priority to each packet buffer based on the service type of each packet buffer; and transmit the data packets in each packet buffer according to the priority of each packet buffer. In some implementations of the apparatus, the service type is associated with an IP address or a time tolerance. In some implementations of the apparatus, the packet buffers correspond to respective predetermined tables of temperature ranges, and the processor is configured to execute the program code stored in the memory to: set a timer for different times to switch different packet buffers between a first operating mode and a second operating mode according to the respective predetermined tables of temperature ranges. In some implementations of the apparatus, the apparatus comprises a power amplifier circuitry, the step of sensing the internal temperature of the apparatus comprises sensing a temperature of the power amplifier circuitry.

The disclosure is directed to a method for throttling uplink data based on a temperature state, used in an apparatus, comprising: sensing an internal temperature of the apparatus; comparing the internal temperature to a corresponding temperature range according to a predetermined table of temperature ranges; and controlling a packet buffer to adjust a current data rate to a corresponding target data rate according to the comparison result.

In some implementations of the method, before the comparing step, the method further comprises: calculating target data rates for each temperature range based on a temperature state; and recording the target data rates for each temperature range in the predetermined table of temperature ranges. In some implementations of the method, before the comparing step, the method further comprises: using a lookup table (LUT) as the predetermined table of temperature ranges; and finding target data rates for each temperature range based on a temperature state from the LUT. In some implementations of the method, the method further comprises: starting a timer to switch the packet buffer between a first operating mode and a second operating mode, wherein when the packet buffer is in the first operating mode, the packet buffer resumes transmitting data packets; and when the packet buffer is in the second operating mode, the packet buffer stops transmitting the data packets. In some implementations of the method, when there are at least two packet buffers in the apparatus, the method further comprises: classifying data packets into at least one data flow classification according to a service type of each packet buffer; and transmitting the data packets to the packet buffers according to the data flow classification for each data packet. In some implementations of the method, the method further comprises: assigning a priority to each packet buffer based on the service type of each packet buffer; and transmitting the data packets in each packet buffer according to the priority of each packet buffer. In some implementations of the method, the service type is associated with an IP address or a time tolerance. In some implementations of the method, the packet buffers correspond to respective predetermined tables of temperature ranges, and the method further comprises: setting a timer for different times to switch different packet buffers between a first operating mode and a second operating mode according to the respective predetermined tables of temperature ranges. In some implementations of the method, the step of sensing the internal temperature of the apparatus comprises sensing a temperature of a power amplifier circuitry.

A detailed description is given in the following implementations with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 shows a multiple access wireless communication system according to one implementation of the disclosure.

FIG. 2 is a block diagram of a transmitter system (also known as access network) and a receiver system (also known as user equipment or UE) according to one exemplary implementation.

FIG. 3 is a functional block diagram of a communication system according to one exemplary implementation.

FIG. 4 is a functional block diagram of the program code of FIG. 3 according to one exemplary implementation.

FIG. 5 is a high level architecture for throttling uplink data according to an implementation of the disclosure.

FIG. 6 is a flow chart of a process illustrating the method for throttling uplink data based on a temperature state according to an implementation of the disclosure with reference to the communication device in FIG. 3.

### DETAILED DESCRIPTION

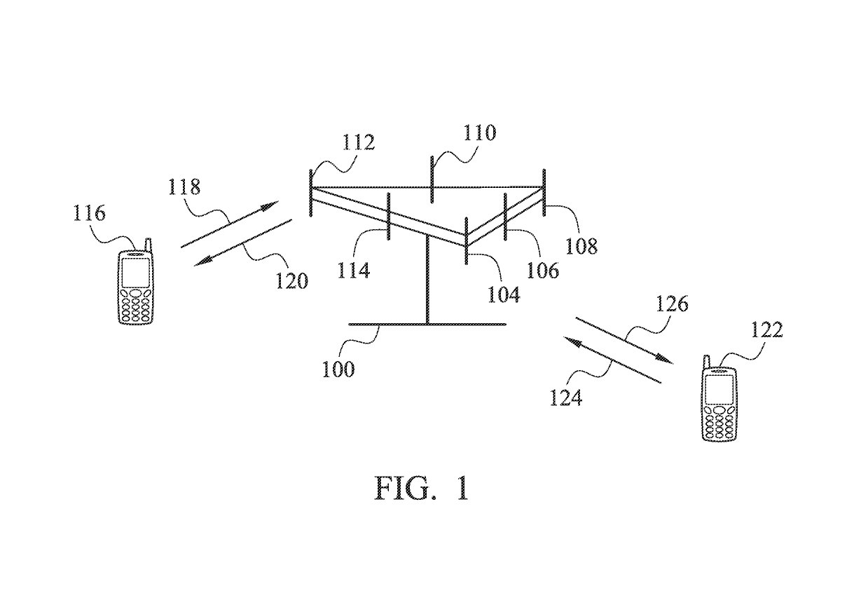

Several exemplary implementations of the present disclosure are described with reference to FIGS. 1 through 6, which generally relate to an apparatus and a method for throttling uplink data based on a temperature state. It should be understood that the following disclosure provides various implementations as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described implementations and/or configurations.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

FIG. 1 shows a multiple access wireless communication system according to one implementation of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD-LTE system (Frequency-Division Duplexing Long Term Evolution system), communication links 118, 120, 124 and 126 may use different frequencies for communication. For example, forward link 120 may use a different frequency then that used by reverse link 118.

Each group of antennas and/or the area in which they are designed to communicate is often referred to as a sector of the access network. In the implementation, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

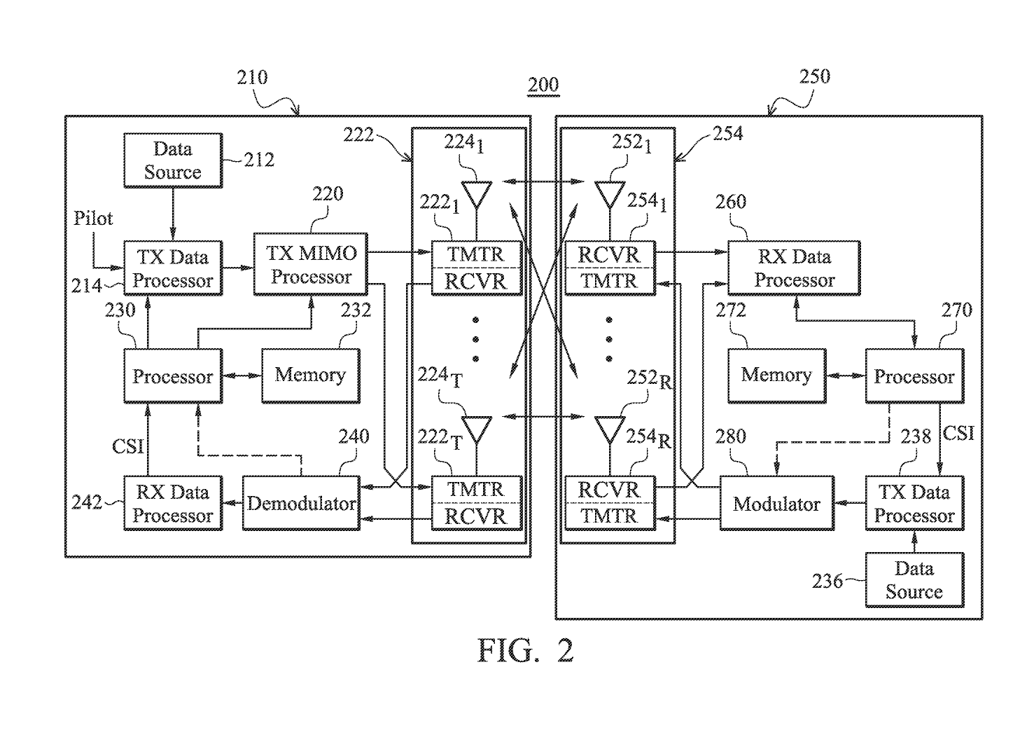

FIG. 2 is a simplified block diagram of an implementation of a transmitter system 210 (also known as the access network (AN)) and a receiver system 250 (also known as access terminal (AT) or user equipment (UE)) in a MIMO system 200. At the transmitter system 210, traffic data for a number of data streams is provided from a data source 212 to a TX (transmitter) data processor 214.

In one implementation, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters 222₁˜222_{T} (TMTR) of transceiver 222, wherein T is a positive integer and N_{T} is the number of 1˜T. In certain implementations, TX MIMO processor 220 applies beamforming weights to the symbols of the data streams and to the antenna from which the symbol is being transmitted.

Each of transmitter 222₁˜222_{T} receives and processes a respective N_{T} modulation symbol stream to provide one or more analog signals, and further conditions (e.g., amplifies, filters, and upconverts) the analog signals to provide a modulated signal suitable for transmission over the MIMO channel. N_{T} modulated signals from transmitters 222₁˜222_{T} are then transmitted from N_{T} antennas 224₁˜224_{T}, respectively.

At receiver system 250, the transmitted modulated signals are received by N_{R} antennas 252₁˜252₈, wherein R is a positive integer and N_{R} is the number of 1˜R, and the received signal from each antenna 252₁˜252₈ is provided to a respective receiver 254₁˜254_{R} (RCVR) of transceiver 254. Each of receiver 254₁˜254₈ conditions (e.g., filters, amplifies, and downconverts) a respective received signal, digitizes the conditioned signal to provide samples, and further processes the samples to provide a corresponding “received” symbol stream.

An RX (receiver) data processor 260 then receives and processes the N_{R} received symbol streams from N_{R} receivers 254₁˜254₈ based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters (TMTR) of transceiver 254, and transmitted back to transmitter system 210.

At transmitter system 210, the modulated signals from receiver system 250 are received by antennas 224, conditioned by receivers (RCVR) of transceiver 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

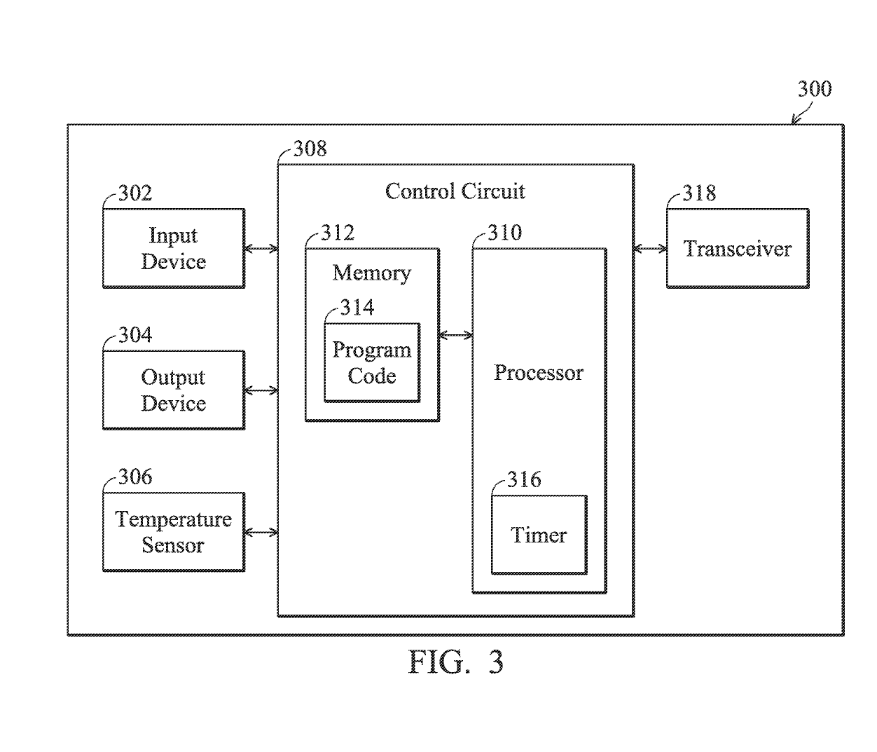

Turning to FIG. 3, this figure shows an alternative simplified functional block diagram of a communication device 300 according to one implementation of the disclosure. As shown in FIG. 3, the communication device 300 in a wireless communication system can be utilized for realizing the UEs (or ATs) 116 and 122 in FIG. 1, and the wireless communications system may be the LTE system. The communication device 300 may include an input device 302, an output device 304, a temperature sensor 306, a control circuit 308, a processor 310 (which may be referred to as a central processor unit (CPU)), a memory 312, a program code 314, a timer 316 and a transceiver 318. The control circuit 308 executes the program code 314 in the memory 312 through the processor 310, thereby controlling an operation of the communications device 300. The control circuit 308 may further execute the program code 314 in the memory 315 through the processor 310 to start at least a timer 316. The communications device 300 can receive signals input by a user through the input device 302, such as a keyboard, touch screen, or keypad, and can output images and sounds through the output device 304, such as a monitor or speakers. The temperature sensor 306 may sense an internal temperature of a component, such as a power amplifier circuitry of the communication device 300 (not shown in FIG. 3), in the communication device 300. The transceiver 318 is used to receive and transmit wireless signals, delivering received signals to the control circuit 308, and outputting signals generated by the control circuit 308 wirelessly.

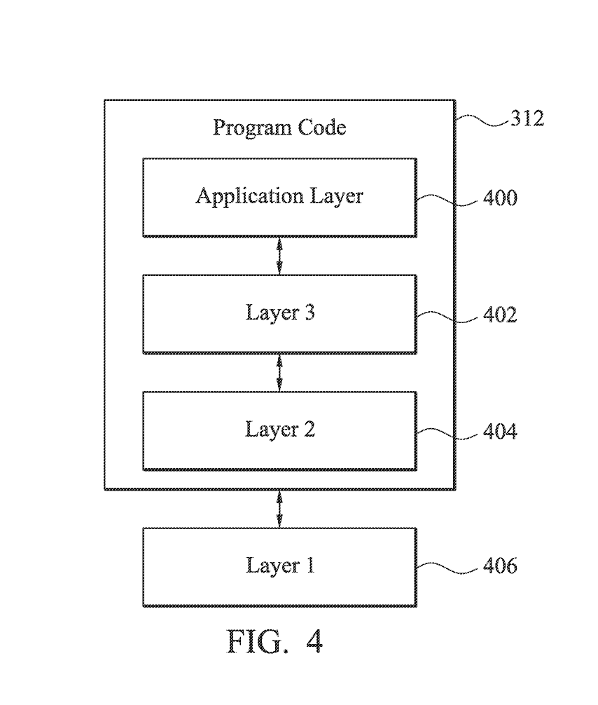

FIG. 4 is a simplified block diagram of the program code 314 shown in FIG. 3 in accordance with one implementation of the disclosure. In this implementation, the program code 314 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

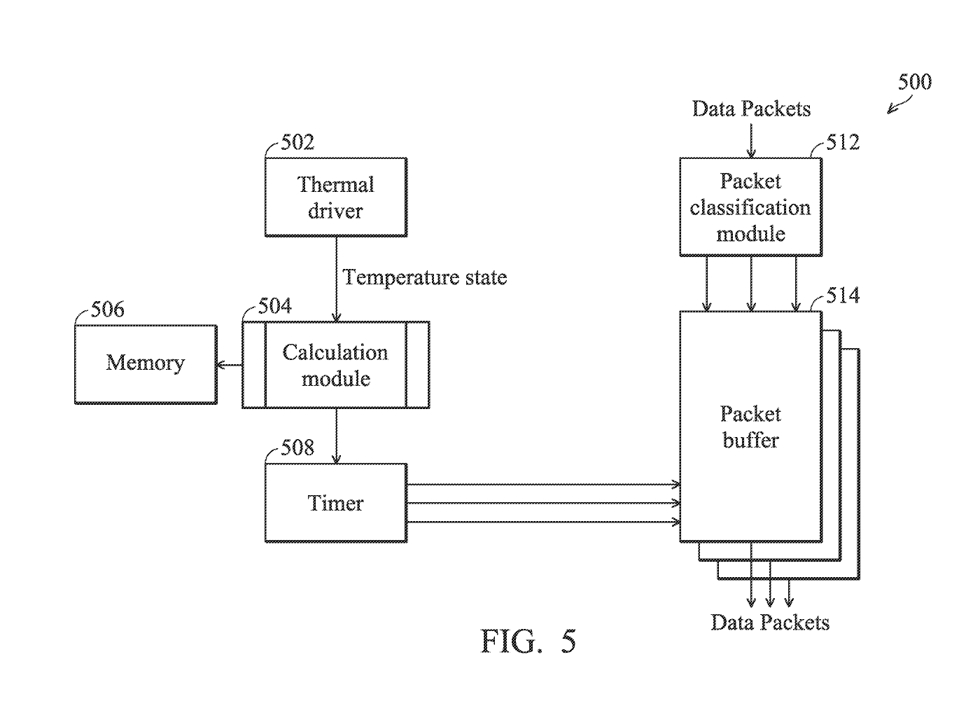

FIG. 5 is a high level architecture 500 for throttling uplink data of an apparatus according to an implementation of the disclosure. A thermal driver 502 can obtain an internal temperature of at least one component of the apparatus, such as a power amplifier circuitry, by a temperature sensor. Then, the thermal driver 502 transmits a temperature state to a calculation module 504 according to the internal temperature. The calculation module 504 calculates target data rates for each temperature range based on the temperature state, wherein the calculation result is recorded in a predetermined table of temperature ranges and is stored in the memory 506. The example of predetermined table of temperature ranges are shown in Table 1.

TABLE 1

| Temperature ranges | Time (ms) | |
|---|---|---|
| (° C.) | First operating mode | Second operating mode |
| 45~46 | 400 | 100 |
| 47~48 | 200 | 200 |
| 49~50 | 100 | 400 |

As shown in TABLE 1, the values listed in the left column represent temperature ranges. The values listed in the right two columns represent a time for controlling a packet buffer in the first operating mode and a time for controlling the packet buffer in the second operating mode. For example, when the internal temperature is within the temperature range of 45° C. to 46° C., a timer can be started for switching the packet buffer between the first operating mode and the second operating mode. In other words, the packet buffer is in the first operating mode for 400 ms, and then is switched to the second operating mode for 100 ms.

In another embodiment, the calculation module 504 can further use a lookup table (LUT) as the predetermined table of temperature ranges to find the target data rates for each temperature range based on the temperature state, wherein the target data rates for each temperature range is defaulted in the LUT and the LUT is stored in the memory 506.

As seen in FIG. 5, the value from predetermined table of temperature ranges can be transmitted to the timer 508. The timer 508 can be set to control the packet buffer 514 in different operating modes according to the predetermined table of temperature ranges. In one implementation, when the packet buffer 514 is in the first operating mode, the packet buffer resumes transmitting data packets. When the packet buffer 514 is in the second operating mode, the packet buffer stops transmitting the data packets.

In another implementation, when there are at least two packet buffers 514, a packet classification module 512 may first classify data packets into at least one data flow classification according to a service type of each packet buffer, wherein the service type is associated with an IP address or a time tolerance of the data packet. After classifying the data packets, the packet classification module 512 transmits the data packets to the corresponding packet buffers 514, respectively, according to the data flow classification of each data packet. The packet buffers 514 transmit the data packets in each packet buffer according to a priority of each packet buffer, wherein the priority of each packet buffer can be assigned based on the service type for each packet buffer.

It should be noted that different packet buffers may correspond to respective predetermined tables of temperature ranges. The timer can be set for different times to switch different packet buffers between different operating modes according to the respective predetermined tables of temperature ranges.

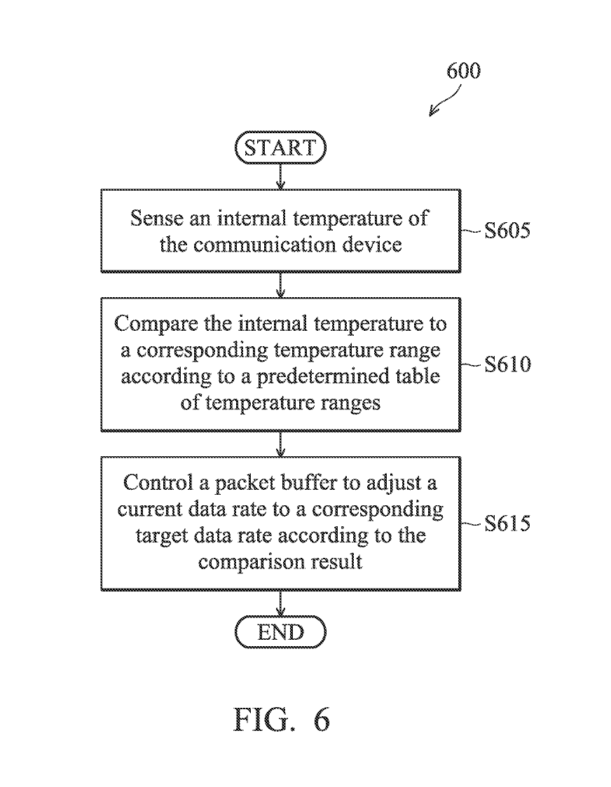

FIG. 6 is a flow chart 600 of a process illustrating the method for throttling uplink data based on a temperature state according to an implementation of the disclosure with reference to the communication device in FIG. 3.

Referring to FIG. 6, in step S605, the temperature sensor senses an internal temperature of the communication device. Next, in step S610, the processor compares the internal temperature to a corresponding temperature range according to a predetermined table of temperature ranges. In step S615, the processor controls a packet buffer to adjust a current data rate to a corresponding target data rate according to the comparison result.

As described above, an apparatus and a method for throttling uplink data based on a temperature state of the exemplary implementations of the present disclosure are capable of automatically adjusting the current data rate. Accordingly, it can avoid the issue of extreme heat caused by the high uplink data rate, and reduces the power consumption of the apparatus.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using another structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those with skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those with skill in the art will further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in various ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the disclosure has been described in connection with various aspects, it will be understood that the disclosure is capable of further modifications. This application is intended to cover any variations, uses or adaptation of the disclosure following, in general, the principles of the disclosure, and including such departures from the present disclosure as come within the known and customary practice within the art to which the disclosure pertains.

What is claimed is:

1. An apparatus for throttling uplink data based on a temperature state in a wireless communication system, the apparatus comprising:
a temperature sensor, sensing an internal temperature of the apparatus;
a processor; and
a memory, operatively coupled to the processor;
wherein the processor is configured to execute a program code stored in the memory to:
compare the internal temperature to a corresponding temperature range according to a predetermined table of temperature ranges; and
control a packet buffer to adjust a current data rate to a corresponding target data rate according to the comparison result.

2. The apparatus for throttling uplink data based on a temperature state in a wireless communication system as claimed in claim 1, wherein before the comparing step, the processor further executes the program code to:
calculate target data rates for each temperature range based on a temperature state; and
record the target data rates for each temperature range in the predetermined table of temperature ranges.

3. The apparatus for throttling uplink data based on a temperature state in a wireless communication system as claimed in claim 1, wherein before the comparing step, the processor further executes the program code to:
use a lookup table (LUT) as the predetermined table of temperature ranges; and
find target data rates for each temperature range based on a temperature state from the LUT,

4. The apparatus for throttling uplink data based on a temperature state in a wireless communication system as claimed in claim 1, wherein the processor includes a timer and is configured to execute the program code stored in the memory to:
start the timer to switch the packet buffer between a first operating mode and a second operating mode,
wherein when the packet buffer is in the first operating mode, the packet buffer resumes transmitting data packets; and
when the packet buffer is in the second operating mode, the packet buffer stops transmitting the data packets.

5. The apparatus for throttling uplink data based on a temperature state in a wireless communication system as claimed in claim 1, wherein when there are at least two packet buffers, the processor is configured to execute the program code stored in the memory to:
classify data packets into at least one data flow classification according to a service type of each packet buffer; and
transmit the data packets to the packet buffers according to the data flow classification of each data packet.

6. The apparatus for throttling uplink data based on a temperature state in a wireless communication system as claimed in claim 5, wherein the processor is configured to execute the program code stored in the memory to:
assign a priority to each packet buffer based on the service type for each packet buffer; and
transmit the data packets in each packet buffer according to the priority of each

7. The apparatus for throttling uplink data based on a temperature state in a wireless communication system as claimed in claim 5, wherein the service type is associated with an IP address or a time tolerance.

8. The apparatus for throttling uplink data based on a temperature state in a wireless communication system as claimed in claim 5, wherein the packet buffers correspond to respective predetermined tables of temperature ranges, and the processor is configured to execute the program code stored in the memory to:
set a timer for different times to switch different packet buffers between a first operating mode and a second operating mode according to the respective predetermined tables of temperature ranges.

9. The apparatus for throttling uplink data based on a temperature state in a wireless communication system as claimed in claim 1, the apparatus comprising:
a power amplifier circuitry,
wherein sensing the internal temperature of the apparatus comprises sensing a temperature of the power amplifier circuitry.

10. A method for throttling uplink data based on a temperature state, used in an apparatus, comprising:
sensing an internal temperature of the apparatus;
comparing the internal temperature to a corresponding temperature range according to a predetermined table of temperature ranges; and
controlling a packet buffer to adjust a current data rate to a corresponding target data rate according to the comparison result.

11. The method for throttling uplink data based on a temperature state in a wireless communication system as claimed in claim 10, wherein before the comparing step, the method further comprises:
calculating target data rates for each temperature range based on a temperature state; and
recording the target data rates for each temperature range in the predetermined table of temperature ranges.

12. The method for throttling uplink data based on a temperature state in a wireless communication system as claimed in claim 10, wherein before the comparing step, the method further comprises:
using a lookup table (LUT) as the predetermined table of temperature ranges; and
finding target data rates for each temperature range based on a temperature state from the LUT,

13. The method for throttling uplink data based on a temperature state as claimed in claim 10, further comprising:
starting a timer to switch the packet buffer between a first operating mode and a second operating mode,
wherein when the packet buffer is in the first operating mode, the packet buffer resumes transmitting data packets; and
when the packet buffer is in the second operating mode, the packet buffer stops transmitting the data packets.

14. The method for throttling uplink data based on a temperature state as claimed in claim 10, wherein when there are at least two packet buffers in the apparatus, the method further comprises:
classifying data packets into at least one data flow classification according to a service type of each packet buffer; and
transmitting the data packets to the packet buffers according to the data flow

15. The method for throttling uplink data based on a temperature state as claimed in claim 14, further comprising:
assigning a priority to each packet buffer based on the service type of each packet buffer; and
transmitting the data packets in each packet buffer according to the priority of each packet buffer.

16. The method for throttling uplink data based on a temperature state as claimed in claim 14, wherein the service type is associated with an IP address or a time tolerance.

17. The method for throttling uplink data based on a temperature state as claimed in claim 14, wherein the packet buffers correspond to respective predetermined tables of temperature ranges, and the method further comprises:
setting a timer for different times to switch different packet buffers between a first operating mode and a second operating mode according to the respective predetermined tables of temperature ranges.

18. The method for throttling uplink data based on a temperature state as claimed in claim 11, wherein the step of sensing the internal temperature of the apparatus comprises sensing a temperature of a power amplifier circuitry.
